(19) United States
(12) Patent Application Publication
(10) Pub. No.: US 2003/0034216 A1
(43) Pub. Date: Feb. 20, 2003

(54) Torque converter having continuously slipping clutch

(76) Inventors: Michael E. Fingerman, West Bloomfield, MI (US); Mark R. Champine, Shelby Township, MI (US); Philip S. Thomas, Sterling Heights, MI (US); Zulfikar Ali, Auburn Hills, MI (US)

Correspondence Address: Mark P. Calcaterra, DaimlerChrysler Intellectual Capital Corporation, CIMS 483-02-19, 800 Chrysler Drive, Auburn Hills, MI, 48326-2757, US

(21) Appl. No.: 09/930,319

(22) Filed: Aug. 15, 2001

(51) Int. Cl. F16D 69/00; F16D 13/74; F16H 45/02

(52) U.S. Cl. 192/3.29; 192/107 R; 192/113.36

(57) ABSTRACT

An annular friction liner for a bridging clutch of a torque converter. The liner has a radially extending friction surface engageable with a reaction surface of the torque converter. The friction surface has a plurality of circumferentially spaced grooves extending from a radially inner edge of the friction surface to a radially outer edge thereof. Each groove extends along a serpentine path and has a series of contiguous groove sections which interconnect end-to-end at a substantial angle to one another. This groove path provides a mixing module for promoting turbulence.

### FIELD OF THE INVENTION

The present invention relates generally to friction liners and more particularly to a friction liner for a torque converter.

### BACKGROUND OF THE INVENTION

Torque converters are used in motor vehicles to provide a drive between the vehicle engine and the automatic transmission. In a torque converter, the transmission of torque is obtained by the circulation of a fluid between bladed elements, one of which is coupled to the engine and the other to the automatic transmission. The two elements are not coupled together and therefore one can slip relative to the other.

The torque converter typically has a lock up clutch with friction material for the purpose of making a direct mechanical coupling between the engine and the automatic transmission. The converter is utilized during vehicle launch and low speed driving and the lock up clutch is utilized at higher vehicle speeds, primarily for fuel economy improvement. Lately, however, mandated fuel economy increases have initiated several developments in more aggressive use of the converter clutch. The clutch would engage earlier and would be allowed to slip continuously. This would improve vehicle fuel economy, and NVH. One of the problems associated with allowing the clutch to slip is the tendency of the friction liner of the clutch, and the oil circulating through the clutch, to overheat. Overheating may result in premature liner wear and may also cause degradation of the circulating oil.

To prevent overheating, it has been proposed to form a plurality of grooves in the surface of the friction liner to permit a circulation of the oil between the liner and the reaction surface. However, the temperature of the oil in the grooves is not uniform which limits the ability of the grooves to have sufficient cooling effect.

### SUMMARY OF THE INVENTION

It has been discovered that the oil circulating in the grooves of a grooved friction liner is much cooler at the bottom of the groove than at the top and therefore, it has been determined that it would be desirable to produce a mixing of the oil in the grooves by causing a turbulence which will bring the oil at the bottom of the groove, which is relatively cool, up to the top of the groove near the friction surface where temperatures are the hottest. By causing a turbulence in the flow, the relatively cooler oil in the bottom comes up to the surface and carries away more heat.

In accordance with the present invention, a groove configuration has been developed which promotes turbulence and therefore results in bringing the cooler oil up from the bottom of the groove to the top. This is accomplished by incorporating specially engineered modules (SEM) or mixing modules in the groove pattern. The automatic transmission fluid going through the mixing module(s) during a clutch “continuous slipping” mode will maximize heat transfer (fluid heat intake) at the clutch interface. Optimized heat transfer allows for extended operation in the continuous slipping mode minimizing transmission fluid degradation and improving fluid material life. This will result in improved fuel economy.

One object of this invention is to provide a groove configuration for a friction liner having the foregoing features and capabilities.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein;

FIG. 1 is a sectional view of a torque converter having a bridging clutch with a friction liner, in accordance with the present invention.

FIG. 2 is an elevational view of a friction liner forming a part of the bridging clutch shown in FIG. 1. The friction liner has mixing modules to greatly improve heat transfer.

FIG. 3 is an enlarged fragmentary view of a portion of the friction liner in FIG. 2, within the circle 3.

FIG. 4 is a sectional view taken on the line 4-4 in FIG. 2.

FIG. 5 is an elevational view of a friction liner of modified construction showing mixing modules of a different configuration.

FIG. 6 is an enlarged fragmentary view of a portion of the friction liner in FIG. 5, within the circle 6.

FIG. 7 is a sectional view taken on the line 7-7 in FIG. 6.

### DETAILED DESCRIPTION OF THE PREFERRED EMBODIMENTS

The following description of the preferred embodiments is merely exemplary in nature and is in no way intended to limit the invention, its application, or uses.

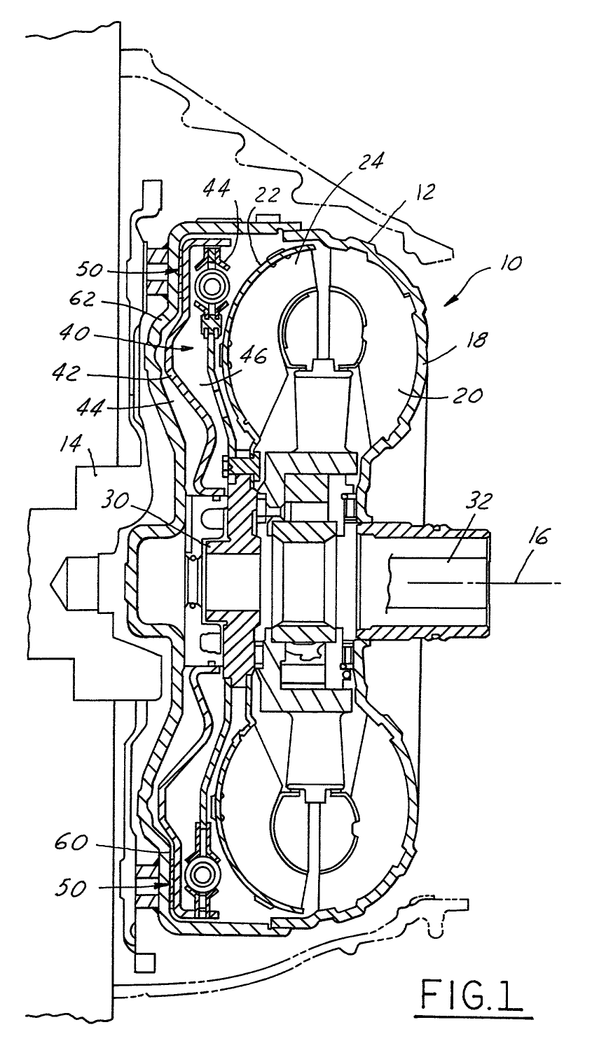

Referring now more particularly to the drawings, FIG. 1 shows a torque converter 10 which is adapted to be interposed between an engine and an automatic transmission of an automotive vehicle.

The torque converter 10 comprises a casing 12 connected to a part 14 of the engine to be driven in rotation by the engine about the axis 16. The casing 12 of the torque converter has a wall 18 to which are connected a series of vanes 20 that serve as a pump for oil in the casing. Inside the casing 12 is a turbine wheel 22 provided with vanes 24. The turbine wheel 22 is mounted on a central sleeve 30 which is splined to a transmission input shaft 32 of the torque converter. The vanes 24, rotating in oil, drive the turbine wheel 22 and the input shaft 32.

A bridging clutch 40 disposed within the casing 12 is provided to couple the casing 12 to the input shaft 32 to rotate the input shaft with the casing when the clutch is engaged. Engagement of the bridging clutch 40 thus normally prevents relative rotational slipping between the casing 12 and the turbine wheel 22, but in certain other instances allows slipping as will be described more fully hereinafter.

The bridging clutch 40 includes a generally radially extending annular clutch plate 42 which is mounted on a part of the casing 12 for axial sliding movement relative thereto. The axially movable clutch plate 42 is also coupled in rotation to the central sleeve 30 through an interposed torsion-damping device 44 for absorbing torque variations that occur during engagement and disengagement of the clutch.

The clutch plate 42 carries an annular friction liner 50 on its outer periphery. The liner 50 is disposed in a radial plane and arranged such that its friction surface 52 will make axial contact against a corresponding radial reaction surface 60 formed on an internal face of a wall 62 of the casing.

The friction liner 50 may for example be made of a composite friction material comprising a resin in which reinforcing elements are embedded. The reinforcing elements may, for example, be cellulose fibers or carbon fibers, or a mixture thereof.

The movable clutch plate 42 defines within the torque converter casing 12 two chambers 44 and 46, so that in effect the plate constitutes a piston. Depending on the prevailing oil pressure in each of the chambers 44 and 46 the clutch plate, or piston as it will now be called, is urged axially in one direction or the other. When the chamber 44 is supplied with oil under pressure, the piston 42 is pushed axially in a direction to cause the friction liner 50 of the bridging clutch to disengage the reaction surface 60. When the chamber 46 is supplied with oil under pressure, the piston 42 is displaced axially in a direction to cause the friction liner of the clutch to engage the reaction surface.

The bridging clutch 40 may be controlled in such a way as to slip on the reaction surface 60 of the casing 12 depending upon the pressure of oil in the chambers 44, 46, which may be moderated to produce the desired amount of slip. Slipping between the friction liner 50 and the reaction surface 60 generates heat and heat is very destructive of the liner itself and of the oil in the casing 12. Although the flow of oil from one chamber to the other tends to have a cooling effect, it is not sufficient, in most cases, to prevent excessive heating.

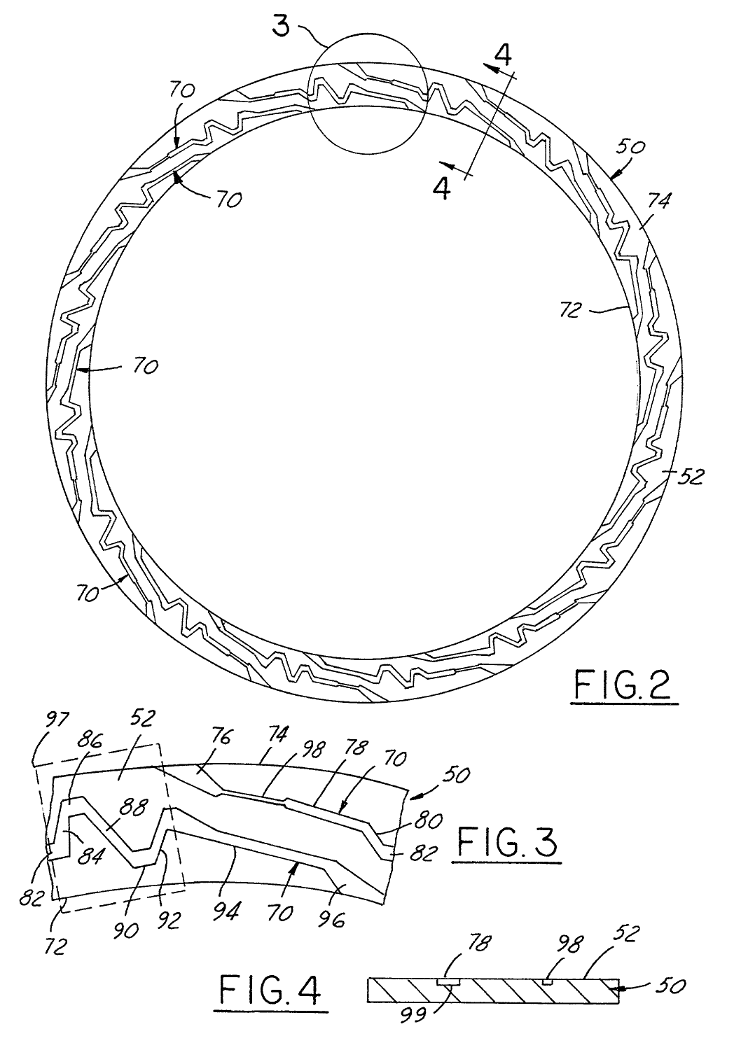

The friction liner 50 in FIGS. 2-4 has a plurality of circumferentially spaced grooves 70 in its friction surface 52. Each groove 70 has a radially inner end opening through a radially inner edge 72 of the friction surface and a radially outer end opening through a radially outer edge 74 thereof. The grooves 70, when the friction liner 50 is in contact with the reaction surface 62, provide channels for the flow of oil in the casing 12. Preferably, the radially inner end of each groove is spaced circumferentially from the radially outer end thereof.

Each of the grooves 70 extends from one end to the other along a serpentine path having a series of contiguous groove sections which interconnect end-to-end. The groove sections are numbered 76, 78, 80, 82, 84, 86, 88, 90, 92, 94 and 96. There is a restriction 98 in the groove section 76 to control fluid flow. Each groove section connects end-to-end with adjacent groove sections at a substantial angle. Note the angle between groove sections 82, 84, groove sections 84, 86, groove sections 86, 88, groove sections 88, 90, groove sections 90, 92 and groove sections 92, 94. The angularly interconnected groove sections provide mixing modules 97 for creating turbulence in the oil flowing through the grooves, and hence cooling. These angles may vary anywhere from 45° to 135° and preferably between 70° and 110°. Most preferred is an angle of about 90°.

The turbulence produced by the mixing modules churns the oil flowing through the grooves and brings the cooler oil at the bottom 99 of the grooves up to the top where elevated temperature tends to occur when there is slipping between the friction surface 52 of the liner 50 and the engaged reaction surface 62.

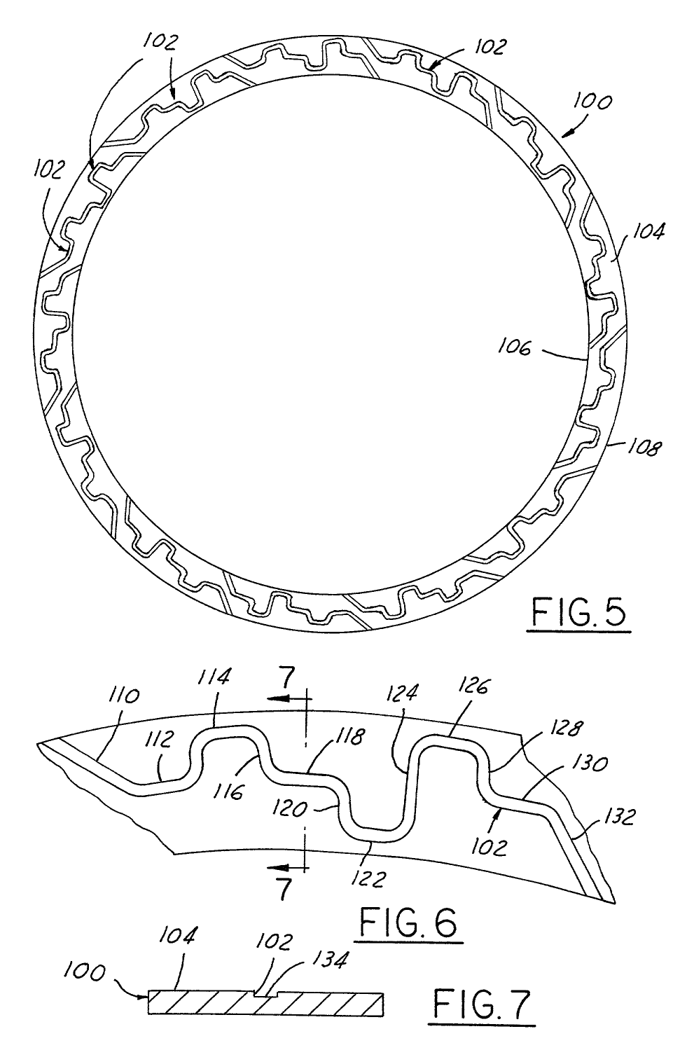

A modified version of the friction liner, designated 100, is shown in FIGS. 5-7. The friction liner 100 has a plurality of circumferentially spaced grooves 102 in its friction surface 104.

Each groove 102 has a radially inner end opening through a radially inner edge 106 of the friction surface and a radially outer end opening through a radially outer edge 108 thereof. Preferably, the radially inner end of each groove 102 is spaced circumferentially from the radially outer end thereof.

Like the friction liner 50 in FIGS. 2-4, each groove 102 extends from one end to the other along a serpentine path and has a series of contiguous groove sections which inter-connect end to end and provide mixing modules as previously described. The groove sections are numbered 110, 112, 114, 116, 118, 120, 122, 124, 126, 128, 130 and 132. Each groove section connects end to end with adjacent grooves sections at a substantial angle. The angle may vary anywhere from 70° to 110° and preferably between 85° and 95°. Most preferred is an angle of about 90°.

As was the case with the grooves in the friction liner 50, the mixing module produced by the serpentine path of the grooves creates turbulence, in order to bring the cooler oil at the bottom 134 of the grooves up to the top to deal more effectively with elevated temperature which occurs when there is slipping between the surface 104 of the liner 100 and the reaction surface 62.

The depth of the grooves in both embodiments may vary, but preferably is on the order of about 0.5 millimeters.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An annular friction liner for a bridging clutch of a torque converter, wherein
said liner has a radially extending friction surface engageable with a reaction surface of the torque converter,
said friction surface has a plurality of circumferentially spaced grooves providing channels for the flow of oil,
each of said grooves has a radially inner end opening through a radially inner edge of said friction surface and a radially enter end opening through a radially outer edge of said friction surface, and
each of said grooves incorporates a mixing module for producing turbulence.

2. A friction liner as defined in claim 1, wherein said each of said grooves extends from one of its ends to the other along a serpentine path having a series of contiguous groove sections with at least two of said groove sections interconnecting end-to-end to form an angle with one another.

3. A friction liner as defined in claim 2, wherein said angle is in a range of 45°-135°.

4. A friction liner, as defined in claim 2, wherein the angle is in a range of 70°-110°.

5. A friction liner as defined in claim 2, wherein the angle is in a range of 85°-95°.

6. A friction liner as defined in claim 2, wherein said angle is on the order of about 90°.

7. A frictional liner as defined in claim 2, further including a flow restriction in each of said grooves.

8. A friction liner as defined in claim 2, wherein an additional two of said groove sections interconnect end-to-end to form a second angle with one another.

9. A friction liner as defined in claim 8, wherein said angles are in a range of 45°-135°.

10. A friction liner as defined in claim 7, wherein said angles are in a range of 70°-110°.

11. A friction liner as defined in claim 8, wherein said angles are in a range of 85°-95°.

12. A friction liner as defined in claim 8, wherein said angles are about 90°.

13. A friction liner as defined in claim 12, wherein the radially inner edge of each of said grooves is circumferentially spaced from the radially outer edge thereof.

14. A frictional liner as defined in claim 13, further including a flow restriction in each of said grooves.

15. A friction liner as defined in claim 2, wherein an additional one of said groove sections interconnects end-to-end with one of the two groove sections to form a second angle therewith.

16. A friction liner as defined in claim 15, wherein said angles are in a range of about 45°-135°.

17. A friction liner as defined in claim 16, wherein at least one of said angles is about 90°.

18. A friction liner as defined in claim 17, wherein the radially inner edge of each of said grooves is circumferentially spaced from the radially outer edge thereof.

19. A frictional liner as defined in claim 18, further including a flow restriction in each of said grooves.
